(19) United States
(12) Patent Application Publication
(10) Pub. No.: US 2015/0248707 A1
(43) Pub. Date: Sep. 3, 2015

(54) Hotel Recommendation Engine Based on Customer Data from Multiple Online Sources

(71) Applicant: Adara, Inc., Mountain View, CA (US)

(72) Inventors: Hongcheng Mi, Foster City, CA (US); Ellen M. Lee, Lake Forest, IL (US)

(21) Appl. No.: 14/195,711

(22) Filed: Mar. 3, 2014

(51) Int. Cl. G06Q 30/02; G06Q 50/12

(52) U.S. Cl. CPC G06Q 30/0269; G06Q 50/12; G06Q 30/0226

(57) ABSTRACT

A recommendations system enables an advertiser to serve a personalized hotel recommendation to a user based on a wide variety of client data associated with the user. The client data describes the user's hotel booking preferences which is matched to hotel property data, describing the characteristics of particular hotel offers. The recommendations system selects a particular hotel offer to recommend to the user by comparing the hotel property data to the client data associated with the user. The recommendations system serves a recommendation to a user based on the selected hotel offer.

### BACKGROUND

1. Field of Art

The disclosure generally relates to the field of online advertising, and more specifically to generating online hotel recommendations.

2. Description of the Related Art

Travelers increasingly book hotel and other travel reservations using web-based resources. In order to attract a particular user to a travel offer (e.g., a hotel reservation), a recommendation system may collect information about a user and present offers (e.g., in the form of ranked search results or targeted ads) that are deemed relevant to a particular user. However, conventional systems base recommendations on very limited information and are therefore unable to generate offers that are particularly well tailored to a given user.

### BRIEF DESCRIPTION OF THE FIGURES

FIG. 1 is a network diagram illustrating one embodiment of a system for providing a hotel recommendation to a user on a client device.

FIG. 2 is a modular diagram illustrating an embodiment of a recommendations server.

FIG. 3 is a flow chart illustrating an embodiment of a process for selecting and recommending a hotel property to a user.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will not be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

A hotel recommendations server generates a targeted advertisement or a set of ranked searched results pertinent to a particular user by drawing on different types of user information from a plurality of data sources. The hotel recommendations server matches a user to a hotel offer by comparing client data associated with the user to hotel property data associated with various offers from different hotel properties.

In one embodiment, the recommendations server obtains client data, including a behavioral data set, a transactional data set, and a loyalty status data set associated with a user. The recommendations server obtains client data from multiple data sources, including one or more client devices associated with the user, one or more web hosting servers, and/or one or more travel provider servers. The recommendations server also obtains hotel property data, which describes various hotel offers. The client data set associated with the user and each hotel property data set are compared and at least one hotel recommendation is selected based in part on the similarity between the client data set at least one hotel property data set.

Although the embodiments herein are described in the context of hotel recommendations, the same principles may be similarly applied to other types of lodging such as, a motel, a bed & breakfast, a hostel, a resort, a campground, a rental, a timeshare, a sublet, a lease, etc.

### Example System Architecture

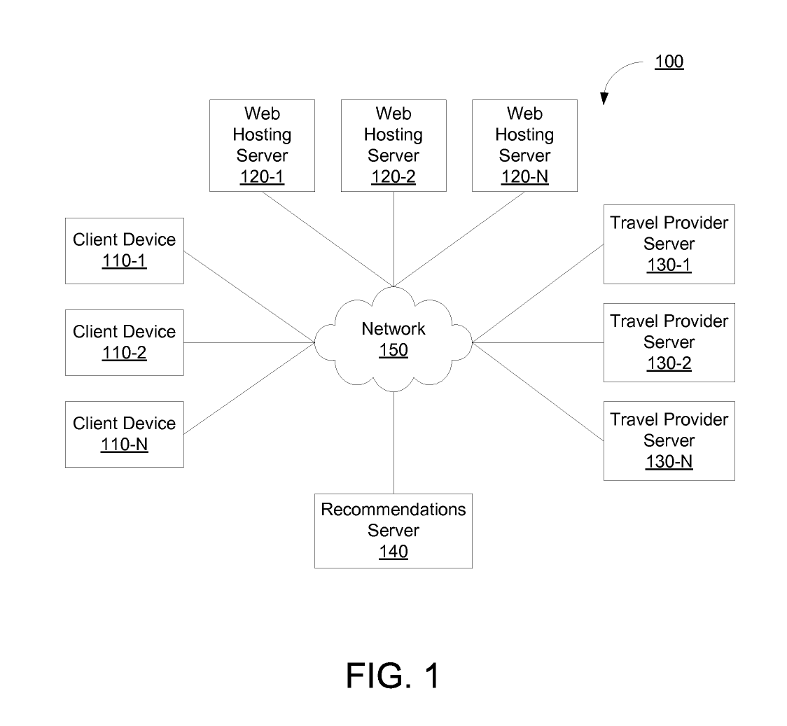

Figure (FIG. 1 is a network diagram illustrating one embodiment of a system for providing a hotel recommendation to a user on a client device. The computing environment 100 comprises one or more client devices 110-1, 110-2, . . . 110-N, web hosting servers 120-1, 120-2, . . . , 120-N, travel provider servers 130-1, 130-2, . . . , 130-N, and a recommendations server 140, all connected by a network 150. Only three client devices 110, three web hosting servers 120, and three travel provider servers 130 are shown in FIG. 1 in order to simplify the description. However, other embodiments of the computing environment 100 can have any number of client devices 110, any number of web hosting servers 120, and any number of travel provider servers 130 connected to the network 150, as well as any number of recommendations servers 140.

In one embodiment, a client device 110 is a computing device used by one or more users to perform various activities including browsing websites hosted by a web hosting server 120 or a travel provider server 130. For example, the client device 110 may comprise a network-capable personal computer (PC), a tablet device, a mobile telephone, a web-enabled television or set top box, etc. The client device 110 may execute a browser application that enables the client to access and display websites hosted by a web hosting server 120 or a travel provider server 130. Furthermore, cookies may be installed on the client device 110 to track device activity in the browser application. Cookies may be exchanged between the client device 110 and the web hosting servers 120, the travel provider servers 130, the recommendations server 140, or any combination of the servers. Other applications besides web browsers (e.g. mobile applications) may similarly access web content and provide information to the web hosting servers 120, the travel provider servers 130, the recommendations server 140, or any combination of the servers relating to the user's activity on the client device 110.

The network 150 represents the communication pathways between the client device 110, the web hosting servers 120, the travel provider servers 130, and the recommendations server 140. In one embodiment, the network 150 includes the Internet, but the network 150 may also include local networks and/or private communications links that are not necessarily part of the Internet. In one embodiment, the network 150 uses standard communications technologies and/or protocols that may include wired and/or wireless interfaces. For example, the network 150 includes communication links using technologies such as Ethernet, 802.11, worldwide interoperability for microwave access (WiMAX), 3 G, 4 G, Long Term Evolution (LTE), code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 150 may be encrypted using any suitable technique or techniques.

The web hosting servers 120 can include one or more computing devices for hosting web sites or other web-based content. The web hosting servers 120 provide web content to a requesting client device 110 and may also collect various data from the client 110. When a client device 110 accesses a website, the client device 110 may receive and store one or more cookies from the web hosting server 120. Furthermore, a web hosting server 120 may request and receive data from cookies previously stored by the client device 110. The exchange of cookies enables the web hosting server 120 to discover past activities performed on the client device 110. By providing and/or monitoring cookies associated with a particular client device 110, the web hosting server 120 may, for example, present the website according to user-customized parameters and/or track and analyze the use of the website.

The travel provider servers 130 can include one or more computing devices for providing hotel property data to a recommendations server 140. The travel provider server 130 may be alternatively embodied as a personal computer, database, or any other suitable computing device. A single travel provider server 130 may include hotel property data from a plurality of hotel properties. For example, a hotel chain may operate a travel provider server 130 that manages hotel property data for every hotel property in the chain. In other cases, a travel provider server 130 may be associated with a single hotel property.

The recommendations server 140 generates a hotel recommendation for a user. The server 140 receives information from any combination of client devices 110, web hosting servers 120, or travel provider servers 130. The information includes client data from one or more client devices 110 and/or web hosting servers 120 and also includes hotel property data from travel provider servers 130. Based on similarities between the hotel property data and the client data, the server 140 recommends a hotel property offer to a user associated with the client data. In one embodiment, the recommendations server 140 compares raw client data to raw hotel property data to match an offer from a hotel property to a user. In another embodiment, to simplify the matching process, a profile may first be created from the client data associated with a particular user that includes a set of metrics describing the user's user preferences across a set of categories.

Similarly, a profile may be created from the hotel property data for each hotel offer that includes a set of metrics describing a particular hotel property's characteristics across the same set of categories. For most efficient matching, the hotel profile may pertain to a particular hotel offer for a particular hotel property, room type, and day, and a given hotel may have many different offers with varying characteristics that will match differently to different users.

The recommendations server 140 matches the user's profile with a hotel profile. The recommendations server 140 presents a recommendation to the user for a best matching hotel offer. The offer may be served in the form of, for example, a targeted advertisement or a hotel recommendation. Alternatively, multiple hotel offers may be ranked based on their respective similarity measures to a particular user, and a ranked list may be provided to the user in response to a search query. By receiving and processing a wide variety of client data, the recommendations server 140 is able to better predict a user's hotel preferences and better select a hotel offer recommendation.

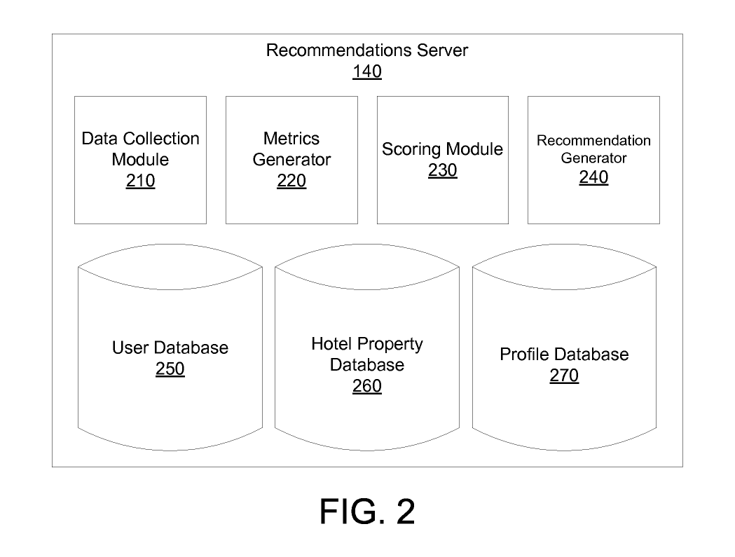

FIG. 2 is a modular diagram illustrating an embodiment of a recommendations server 140. In the illustrated embodiment, the recommendations server 140 comprises multiple modules including a data collection module 210, a metrics generator 220, a scoring module 230, and a recommendation generator 240. Additionally, the recommendations server 140 includes databases, such as a user database 250, a hotel property database 260, and a profile database 270. In other embodiments, the database server 140 may include additional, fewer, or different modules for various applications.

The data collection module 210 receives client data pertaining to the client device 110 associated with a user. Client data may refer to any web, browsing, or application activity on the client device 120 or user information (e.g., profile information) associated with the user of the client device or to activity on the client device itself. Client data may also refer to information received from an online user account accessible through a user's client device 110. Client data associated with the particular user may be obtained from one or more online sources, including client devices 110 associated with the user, web hosting servers 120, or travel provider servers 130 and are stored in the user database 250. The data collection module 210 may receive additional data, such as an internet protocol (IP) address, along with the client data that identifies the source of the client data; this data may be used to correlate client data to a particular user or to serve a recommendation to the user.

Client data includes various data relating to user activities on a specific client device 110. In one embodiment, client data includes at least one of: (1) behavioral data, (2) transactional data, and (3) loyalty status data. Other relevant data not covered by the listed categories may also be considered client data. Behavioral data comprises information describing activity on a specific client device 110. Behavioral data may include, for example, a web browsing history associated with the user's client device 110, a set of search terms entered into a search engine, a timeframe associated with a website access, a default language used on the client device 110, a set of advertisements viewed on the client device, mobile applications accessed by the client device, or other activities of the client device.

Transactional data comprises information describing web-based transactions performed using the client device 110. Transactional data may include, for example, a history of purchases made on a client device 110 including information such as the product vendor, the specific product purchased, timing of the purchase, or the purchase amount. Specifically, the history of purchases made on a client device 110 may include information identifying a hotel, airline, restaurant, etc. associated with the reservation, a destination associated with the transaction, or a timeframe associated with the reservation.

Loyalty status data comprises information related to loyalty programs associated with the client device 110. In this context, a loyalty program is a program or club associated with a hotel property, consortium of hotel properties, or brand that typically rewards members for continued patronage. Examples of loyalty programs include, but are not limited to, valued guest programs or frequent guest programs for hotels. Embodiments of loyalty status data include a set of loyalty program usernames or identification numbers used on the client device 110, a set of loyalty program websites accessed by the client device 110, or a set of purchases made with the client device 110 using a loyalty program. While loyalty status data may be collected from loyalty program profiles, loyalty status data may be additionally or alternatively collected from web activity or browsing history.

Furthermore, the client data includes a timeframe for a user's planned hotel reservation. The timeframe may be explicitly defined by the user (e.g., by entering a timeframe into a set of search terms) or implicitly; for example, the timeframe of the user's stay may be determined using travel dates associated with a set of flight reservations for the trip or reservation dates associated with previous searches or purchases.

Furthermore, the data collection module 210 receives hotel property data from one or more travel provider servers 130. The hotel property data includes price data and availability data for a particular hotel property or particular rooms within a hotel property. Price data reflects the price or price range associated with hotel rooms at the hotel property while availability data provides the number of rooms available at the hotel property, optionally broken down by room type, size, cost, review rating, or other factors. Furthermore, the hotel property data may include the hotel's location, a set of amenities (e.g., a coffeemaker, a pool, free breakfast, an airport shuttle, or free WiFi) offered by the hotel property, or a set of loyalty programs associated with the hotel valid within the timeframe associated with the user. However, other forms or examples of hotel property data not explicitly disclosed in the aforementioned examples may also be received by the data collection module 210. Since hotel room price and availability may change over time, the hotel property data may be valid only within a specific timeframe. This timeframe may be additionally received by the data collection module 210.

The metrics generator 220 processes raw client data associated with a user into a profile that describes the associated user's hotel booking preferences. The metrics generator 220 creates metrics from client data using a natural language classifier, a computer-based neural network, a machine learning algorithm, or another computer-implemented program known to a person having ordinary skill in the art.

In addition to generating the user profile based on the metrics described above, the metrics generator 220 generates at least one hotel offer profile for each hotel property from the raw hotel property data and stores the offer profile in the profile database 270. The offer profile describes characteristics of a particular offer for a hotel room reservation at a specified hotel property for a specified date. Since hotel property data varies over time, the profile and metrics within the profile may be specific to a timeframe in general or specific to the timeframe associated with the client data. The set of metrics are categorized using the same set of aforementioned categories that describe the user's user preferences.

The user's profile and hotel offer profiles each include a set of metrics that can be compared and matched across a plurality of categories. Examples of metrics include (1) location, (2) amenities, (3) loyalty status, (4) booking behavior, (5) urgency, and (6) price range. It is noted that a metric in the user's profile may be associated with one or more categories.

The location category includes a set of metrics that describes a user's preferred location for the hotel property. For example, the metric may indicate how far the user typically books from the intended travel destination; for example, a user visiting San Francisco may only be willing to stay at a hotel property within 5 miles from downtown San Francisco. This information may be determined based on prior booking behavior and/or search behavior. The offer profile for a hotel describes the location of the hotel property, which can be directly compared to the user's location preferences. A location metric for a hotel offer may include the mailing address for the hotel property or a set of GPS coordinates that indicate the hotel property's location. Another metric may be the distance from a known location (e.g., San Francisco International Airport, downtown San Francisco) to the hotel property.

The metrics associated with the amenities category describe a set of amenities that the user tends to seek out in a hotel property, which can be compared against the offered amenities for a particular hotel offer. In this context, amenities may include room-specific amenities (e.g., a balcony, a coffeemaker, air conditioning, free WiFi, etc) and/or property-specific amenities (e.g., an airport shuttle, free breakfast, a spa, a business center, a pool, etc). For example, an amenities metric may include a list of desired amenities, such as an ocean view, a balcony, and a king-size bed. Another metric may indicate that the user will only consider offers from hotel properties with an airport shuttle. This information may be determined based on particular amenities that the user searches for using hotel search websites, or may be based on the amenities offered at hotels where the user has previously stayed. These metrics may be compared against the amenities associated with a particular hotel offer.

Metrics in the loyalty status category describe a user's status in various loyalty programs and history of booking based on particular loyalty programs. For example, metrics associated with the loyalty status category may indicate that the user is associated with a certain hotel chain's loyalty program or that the user has accumulated a certain number of rewards points. Another metric may indicate that the user will only consider hotel offers from a hotel property which is a part of a loyalty program the user is currently a member of. Other loyalty status metrics may describe the strength of the user's affiliation with the loyalty program, such as how long the user has been a member of the program. The loyalty metrics can be directly compared against loyalty programs accepted by the hotel property. Furthermore, the loyalty metrics may be compared to a hotel offer based on an ability to pay for a hotel reservation with accumulated reward points, or a number of rewards points that the user will earn by accepting a particular hotel offer.

Booking behavior metrics describe a user's booking behavior, such as how far in advance the user books hotel reservations. For example, a booking behavior metric may describe how far in advance or at what time of day a user typically books a hotel room. Other metrics may describe how the user books tickets; for example, a metric may indicate which websites the user previously used to book a hotel. Furthermore, booking behavior metrics may indicate that a user makes other reservations concurrently with the hotel reservation. For example, a booking behavior metric may indicate that a user typically makes car rental reservations or airline flight reservations concurrently with hotel reservations. Booking behavior metrics may be matched against availability dates for a particular hotel offer relative to the current date, in order to find offers that best match the user's booking behavior.

Urgency metrics describe the user's responsiveness to an urgency indicator in an advertisement or other online hotel offer. A metric in this category may be a likelihood that the user will act on an advertisement stating that there are a limited number of hotel rooms left or that a hotel offer is for a limited time only. Other metrics may describe how many times a user has acted on previous urgent advertisements and under what conditions the user acted. Furthermore, additional metrics may describe urgency conditions under which the user is likely to act. For example, the user may be unlikely to act unless there is only one hotel room eligible for the hotel offer available. The urgency metrics can be compared against an urgency status associated with a particular offer, such as the number of rooms available or a time before an offer expires in order to find an offer that the user is most likely to respond to.

Metrics in the price category describe the price range a user is interested in. A metric in the price category may indicate a maximum or average amount the user is willing to pay per night for a hotel room, or the maximum or average total amount the user is willing to spend based on prior transactions or online searches. Another metric in the price category may be an average cost per night of previously reserved hotel rooms. The price metrics may be compared against price associated with a particular hotel offer to find offers within the user's preferred price range. This comparison may be based on a price per night of the hotel room, the total cost of the reservation, and/or discounts for the hotel reservation applicable to the user based on the user's membership in a loyalty program or based on other client data.

The metrics generator 220 may create multiple hotel property profiles for each hotel property based on the type of hotel room or other reservation conditions. For example, the generator 220 may create a hotel property profile for a penthouse suite of a hotel property and a second hotel property profile for a budget hotel room at the same hotel property. While both profiles are associated with the same hotel property, the listed amenities metrics and price metrics may greatly differ between the two profiles. In another embodiment, the metrics generator 220 may create multiple hotel property profiles based on different timeframes. For example, the generator 220 may create a hotel property profile valid for a particular day when the hotel has availability for particular room type at a particular price.

The scoring module 230 generates a similarity measure between a user's profile and at least one offer profile based on the metrics described above. In one embodiment, the scoring module 230 generates a similarity measure for each category of metrics shared between a pair of profiles, which includes the user's profile and a hotel offer profile. The scoring module 230 may calculate a similarity measure using a machine learning algorithm, regression analysis, a similarity function, a distance calculation, or any other relevant mathematical analysis, wherein the similarity measure may be a correlation coefficient, a confidence interval, a distance between two points, or any other measure of similarity or correlation apparent to a person having ordinary skill in the art. The similarity measures may be stored in a vector associated with a pair of profiles. Furthermore, the scoring module 230 generates an overall similarity measure associated with the pair of profiles. The overall similarity measure may be a weighted average of each category's similarity measure, a lowest or highest similarity measure, or another method of determining an overall value.

The recommendation generator 240 generates a recommendation based on the similarity measures to present to the user. Different methods of selecting a recommendation may include, for example, recommending the highest-ranked offer based on the overall similarity measure or selecting a plurality of offers that exceed a similarity threshold. The recommendation may be an online advertisement embodied in text, graphics, sound, video, an interactive application, or any other format familiar to a person having ordinary skill in the art of online advertising. Alternatively, the hotel property recommendation is integrated into a set of search results on a website. The recommendation generator 240 provides the recommendation for display to the client device 110 associated with the user by sending the recommendation through the network 150 to the client device 110.

### Generating a Hotel Recommendation

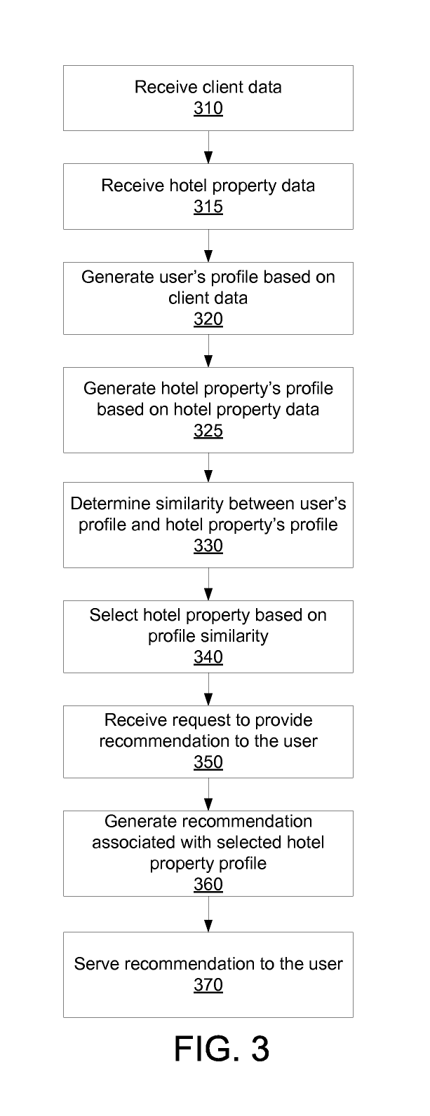

FIG. 3 is a flow chart illustrating an embodiment of a process for selecting and recommending a hotel offer to a user. In one embodiment, the process of FIG. 3 is enabled by a software (or computer program product) application running on a hotel recommendations server 140. For example, the hotel recommendations server 140 may comprise computer-executable instructions stored to a non-transitory computer-readable storage medium that when executed by a processer causes the processor to perform the steps of FIG. 3 below.

The recommendations server 140 receives 310 client data associated with a user. The client data may be received 310 from one or more client devices 110, web hosting servers 120, or travel provider servers 130. The client data may also be received 310 from an online profile associated with the user. The client data includes a set of behavioral data, a set of transactional data, and a set of loyalty status data. Furthermore, the client data may include or be associated with an internet protocol (IP) address for the user's client device 110 and/or a timeframe for the hotel reservation. Client data is subsequently stored on the recommendations server 140.

The recommendations server 140 receives 315 hotel property data from travel provider servers 130. The server 140 may receive 315 hotel property data from travel provider servers 130 before, during, or after client data is received 310 from the client devices 110 and web hosting servers 120. Hotel property data is stored on the recommendations server 140.

The recommendations server 140 generates 320 a profile for the user based on the received client data associated with the user. The user's profile describes a particular user's user preferences in a hotel property and includes a set of metrics across a plurality of categories generated by the recommendations server 140 from the received client data. The categories encompass, for example, (1) location, (2) amenities, (3) loyalty status, (4) booking behavior, (5) urgency, and (6) price range.

The recommendations server 140 generates 325 a hotel offer profile based on the received hotel property data. The hotel offer profile includes a set of metrics generated from the received hotel property data that describe the characteristics of the hotel offer. Hotel offer profiles may be specific to a room type offered by the hotel or specific to a particular reservation timeframe. Thus, multiple hotel property profiles may be associated with a single hotel property. The metrics are associated with one or more of the aforementioned categories of metrics and are for comparing directly to corresponding user metrics.

The recommendations server 140 determines 330 the similarities between the user's profile and each of the hotel offer profiles. The similarity of the profiles may be quantified using a similarity measure, wherein the similarity measure is a correlation coefficient, a confidence interval, a distance between two points, or any other measure of similarity or correlation apparent to a person having ordinary skill in the art. Furthermore, the recommendations server 140 may create an overall similarity measure based on the similarity measures for each metric and/or category.

The recommendations server 140 selects 340 a hotel offer profile based on the associated similarity measures. The selection 340 may be based on one or more similarity scores between the user's profile and the hotel offer profile. For example, the recommendations server 140 may select 340 a hotel offer profile based on a similarity score for a single metric or category. Alternatively, the recommendations server 140 may select 340 a hotel offer profile based on an overall similarity measure to the user profile.

The recommendations server 140 receives 350 a request to provide a recommendation to the user. The request may be received from a client device 110 associated with the user or a web hosting server 120 associated with the user.

The recommendations server 140 generates 360 a recommendation based on the selected hotel property profile. The recommendation may be created by the recommendations server 140. In another embodiment, the recommendation may be retrieved from a database associated with the recommendations server 140.

The recommendations server serves 370 the recommendation to the user. The recommendation may be sent to a client device 110 associated with the user. The client device 110 associated with the user may be identified based on additional information, such as an IP address, associated with the user's client data. In another embodiment, the recommendations server 140 instead provides the recommendation to a web hosting server 120, which uses the information to serve an advertisement or a recommendation to the user's client device 110.

### Additional Configuration Considerations

One example embodiment of the system and method above serves a hotel recommendation to a user based on the user's web activity. The web activity may include loyalty status information that describes loyalty programs the user is associated with. Based on the user's web activity, the hotel recommendations server 140 generates a hotel recommendation for a specific hotel property. By generating a hotel recommendation for a hotel property, the recommendations server 140 is able to offer specific, local recommendations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, which by way of example are executable by the client devices 110 or servers 120, 130, 140 described above. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules and can be stored as instructions in a memory or other storage.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for a hotel recommendation engine through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope.

What is claimed is:

1. A method for generating a personalized hotel recommendation for a user, comprising:
receiving client data associated with the user, the client data comprising:
a behavioral data set representing web activity on the client device;
a transactional data set representing a captured web transaction performed on the client device; and
a loyalty status data set representing a loyalty membership associated with a user of the client device;
receiving hotel property data associated with one or more hotel offers, the hotel property data associated with each of the one or more hotel offers specifying a hotel property, price, and reservation dates;
generating a user profile associated with the user based on the client data associated with the user;
generating a plurality of offer profiles associated with different hotel offers based on the hotel property data;
determining, by a recommendations server, similarity measures between the user profile and each of the plurality of offer profiles;
selecting, by the recommendations server, a selected offer profile based on the similarity measures associated with each of the plurality of offer profiles;
receiving a request to serve a recommendation to a user;
generating a hotel recommendation based on the hotel property offer associated with the selected offer profile; and
providing the generated recommendation for presentation to the user.

2. The method of claim 1, wherein the hotel property data associated with each of the one or more hotel offers further specifies at least one of a room type, a location, and an amenity.

3. A method for generating a personalized hotel recommendation for a user, comprising:
receiving client data associated with a user;
receiving a plurality of sets of hotel property data, each set of hotel property data associated with a hotel property offer, and wherein each set of hotel property data specifies a hotel property, price, and reservation dates;
generating a plurality of similarity measures, each similarity measure representing a similarity between the client data and one of the sets of hotel property data;
selecting a hotel property offer from the plurality of hotel property offers based on the plurality of similarity measures; and
responsive to a request to serve a recommendation to a user, serving a recommendation for the selected hotel property offer to a client device associated with the user.

4. The method of claim 3, wherein the client data comprises:
a behavioral data set representing web activity on the client device;
a transactional data set representing a captured web transaction performed on the client device; and
a loyalty status data set representing a loyalty membership associated with a user of the client device.

5. The method of claim 3, further comprising:
processing the client data and each of the sets of hotel property data into a set of metrics across a plurality of categories, the plurality of categories comprising at least one of location, amenities, loyalty status, booking behavior, urgency, and price range.

6. The method of claim 5, further comprising:
generating a user profile describing the user's preferences in a hotel property based on the received client data, the user profile comprising user metrics across the plurality of categories.

7. The method of claim 5, further comprising:
generating offer profiles for each of the plurality of hotel offers, each offer profile describing the hotel offer based on the received hotel property data, and each offer profile comprising offer metrics across the plurality of categories.

8. The method of claim 5, wherein generating the plurality of similarity measures comprises:
generating a similarity measure for each category in the plurality of categories.

9. The method of claim 8, wherein generating the plurality of similarity measures further comprises:
generating an overall similarity measure based on the similarity measures for each category in the plurality of categories.

10. The method of claim 3, wherein each set of hotel property data further specifies at least one of a room type, a location, and an amenity.

11. A non-transitory computer-readable storage medium storing instructions for serving a targeted advertisement to a first client device, the instructions, when executed by a processor, cause the processor to:
receive client data associated with a user;
receive a plurality of sets of hotel property data, each set of hotel property data associated with a hotel property offer, and wherein each set of hotel property data specifies a hotel property, a price, and reservation dates associated with a particular offer;
generate a plurality of similarity measures, each similarity measure representing a similarity between the client data and one of the sets of hotel property data;
select a hotel property offer from the plurality of hotel property offers based on the plurality of similarity measures; and
responsive to a request to serve a recommendation to a user, serve a recommendation for the selected hotel property offer to a client device associated with the user.

12. The computer-readable storage medium of claim 11, wherein the client data comprises:
a behavioral data set representing web activity on the client device;
a transactional data set representing a captured web transaction performed on the client device; and
a loyalty status data set representing a loyalty membership associated with a user of the client device.

13. The computer-readable storage medium of claim 11, wherein the computer readable storage medium further has instructions encoded thereon that, when executed by the processor, cause the processor to:
process the client data and each of the sets of hotel property data into a set of metrics across a plurality of categories, the plurality of categories comprising at least one of location, amenities, loyalty status, booking behavior, urgency, and price range.

14. The computer-readable storage medium of claim 13, wherein the computer readable storage medium further has instructions encoded thereon that, when executed by the processor, cause the processor to:
generate a user profile describing the user's preferences in a hotel property based on the received client data, the user profile comprising user metrics across the plurality of categories.

15. The computer-readable storage medium of claim 13, wherein the computer readable storage medium further has instructions encoded thereon that, when executed by the processor, cause the processor to:
generate offer profiles for each of the plurality of hotel offers, each offer profile describing the hotel offer based on the received hotel property data, and each offer profile comprising offer metrics across the plurality of categories.

16. The computer-readable storage medium of claim 13, wherein the computer readable storage medium has further instructions for generating the plurality of similarity measures encoded thereon that, when executed by the processor, cause the processor to:
generate a similarity measure for each category in the plurality of categories.

17. The computer-readable storage medium of claim 16, wherein the computer readable storage medium has further instructions for generating a plurality of similarity measures encoded thereon that, when executed by the processor, cause the processor to:
generate an overall similarity measure based on the similarity measures for each category in the plurality of categories.

18. The computer-readable storage medium of claim 11, wherein each set of hotel property data further specifies at least one of a room type, a location, and an amenity.
